(19) United States
(12) Patent Application Publication
(10) Pub. No.: US 2008/0281516 A1
(43) Pub. Date: Nov. 13, 2008

(54) ADVERTISING MANAGEMENT IN A WIRELESS CLIENT-SERVER NAVIGATION SYSTEM

(76) Inventor: Ian Cummings, Ypsilanti, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/113,989

(22) Filed: May 2, 2008

Related U.S. Application Data
(60) Provisional application No. 60/915,515, filed on May 2, 2007.
(60) Provisional application No. 60/941,146, filed on May 31, 2007.

(51) Int. Cl. G01C 21/36; G06Q 30/00

(52) U.S. Cl. 701/210; 705/14; 705/10

(57) ABSTRACT

In a vehicle navigation system, advertising content is provided in a way that is noticeable, does not interfere with the navigation function of the device, and is relevant to the user's desires. If, after being provided with advertising content, the user indicates a desire to travel to a location relevant to the advertising content, the navigation system will guide him to the location with minimal further user input. In response to a user request for locations fitting certain criteria, icons indicating the position of locations fitting the criteria are displayed. Locations for which advertising information is available are indicated with an icon visually differentiable from icons for which no such information is available. When the user selects a location for which advertising content is available, the advertising content is presented. A control is also presented with which the user can command the navigation system to guide him to the selected location. If the control is activated the navigation system generates a route between the user's current location, and the selected location guides the user to the selected location. If the control is activated when the navigation system is already guiding the user along a route, the selected location is added to the current route.

### REFERENCE TO RELATED APPLICATION

This application claims priority from U.S. Provisional Patent Application Serial Nos. 60/915,515, filed May 2, 2007 and 60/941,146, filed May 31, 2007, the entire content of both applications is incorporated herein by reference.

### FIELD OF THE INVENTION

This invention relates to computerized navigation, in particular to providing advertising content on a computerized navigator.

### BACKGROUND OF THE INVENTION

While current navigation devices are primarily used to guide a user from his current location to a selected address, they have the potential to further assist users by providing additional information relevant to their destination, path, or current location. In particular, they have the potential to help users select destinations when the user is only able to provide a limited amount of information about their desired destination. For example, they can guide a user to an acceptable location if he only knows that he wants to buy a pipe wrench at the closest appropriate location, instead of being able to specify that he wants to travel to the Home Depot store at 123 Main Street.

This potential to provide additional information to the user is greatly enhanced by adding a wireless communication device to the navigation device. With this addition, a user is able to access more information to aid his travel than could be stored on a standalone navigation device. Available information also becomes more timely, since current events such as promotional sales and weather conditions can be provided to the user, whereas in a device without the capability to receive such information via a wireless device, onboard information quickly becomes outdated and irrelevant.

One form of information that can be provided to a user is advertising content. Provision of advertising content can have great value to the user, the advertisement provider, and the device manufacturer.

An advertisement on a navigation device can mace users aware of places to purchase goods and services they desire. An advertisement can provide detail about goods and services relevant to users' decision regarding where they will purchase goods and services. Ads can also provide information about advantageous opportunities to purchase goods and services like sales events.

An advertisement on a navigation device is also valuable to an advertiser in that it allows them to make potential customers aware of their product, to entice them to purchase it, and persuade them to purchase it from the advertiser rather than another party. Advertisements can also be valuable to device manufacturers inasmuch as they can charge a fee for providing advertising content on the navigation device.

The value of an advertisement on a navigation device is enhanced by two factors. First, a navigation device is aware of the user's position and is thus able to select advertising content that is most relevant to a customer by virtue of his location. Second, if a customer is using his navigation device to seek a location to make a purchase, an advertisement has a higher probability of inducing an immediate sale for the advertiser than if the advertisement was provided by some other means when the customer was only considering malting a purchase.

One of the difficulties of providing advertisements to users of navigation devices is that such provision can annoy users, inciting them to ignore the advertisement, act contrary to the desired behavior, or disable advertisements altogether. For example, a pop-up advertisement on the screen of a navigation device can interfere with using the device for navigation, irritating a user. Advertisements relevant to a user's location but not relevant to a user's desire can also be irritating, even if delivered via a text message or audio message that does not interfere with the fundamental use of the navigation device.

Another difficulty of providing advertisements via navigation devices is providing an advertisement that the user will notice. Navigation device screens are generally not large, and if advertising content is small enough that it does not obscure navigation content, then it may be too small to be noticed by the customer.

### SUMMARY OF TIE INVENTION

This invention resides in a system and method of conveying advertising information to a user of a navigation system. A user input or information about the user is received by the system and used to infer which advertising content available to the system might be of interest to the user. The user is informed that advertising content is available which may be of interest to the user and, if the user wishes to receive the advertising content, a command is issued to the system and the advertising content is conveyed to the user.

A request may be received from the user to guide the user to a location associated with the advertising content, in which case guidance will be provided to the location. In the preferred embodiment, no input by the user is required for the navigation system to generate the guidance. The user may provide additional information to modify the guidance provided by the navigation system. A global positioning satellite (UPS) system may be used to determine location(s).

The information about the user may include the user's current, previous, or planned position. Alternatively, such information may include demographic information about the user, or a previous input to the navigation system by the user. The guidance may be provided through video, images, text, voice, or tones.

The user input may include a request to be guided to a location, or a request for the location of places matching criteria provided by the user. The criteria may include proximity to the user, and the locations may be businesses.

The availability of advertising content may be communicated to the user by displaying text or icons on a screen. Indicators for locations for which advertising content is available may be presented in a manner visually discernable from indicators for locations for which advertising content is not available. The advertising content may be in audible, visual, image, or video form, and may include a coupon.

The advertising content may be stored at the location of the user or communicated to the user from a remote location. The advertising content may include a telephone number, address, email address or other information enabling the user to contact a party associated with the advertisement.

If the navigation system is previously guiding the user along a route, the location associated with the advertisement is added to the route, and guidance may be provided to the user to follow the modified route. The location associated with the advertisement may be added to the existing route such the route is optimized to minimize distance along the route or minimize travel time in following the route. The modified route is preferably generated and the guidance provided without further user input.

Information may be provided to the user regarding straight-line distance, route distance, or estimated travel time from the user's position to the location associated with the advertisement. If the navigation system is previously guiding the user along a route, information may be provided to the user regarding additional travel distance or time if the location associated with the advertisement is added to the current route.

The navigation system may be a wireless client-server navigator, and the user may provides commands to the navigation system via a touchscreen, in which case user commands to provide advertising information and user commands to provide guidance to a destination may be differentiated by the manner in which the user interacts with the touchscreen.

### BRIEF DESCRIPTION OF THE DRAWINGS

FIG. 1 shows an example moving map display on a navigation device;

FIG. 2 shows the map display after a request by the user for nearby fast food restaurants. The differentiated icon of the McDonalds location indicates that advertising content is present;

FIG. 3 shows the navigation system display after the user has elected to view the McDonalds advertising content. Controls to be routed to the McDonalds location and to return to the map display are presented; and

FIG. 4 shows the map display after the user has requested to be guided to the McDonalds. The location of the McDonalds has been added to the previous route.

### DETAILED DESCRIPTION OF THE INVENTION

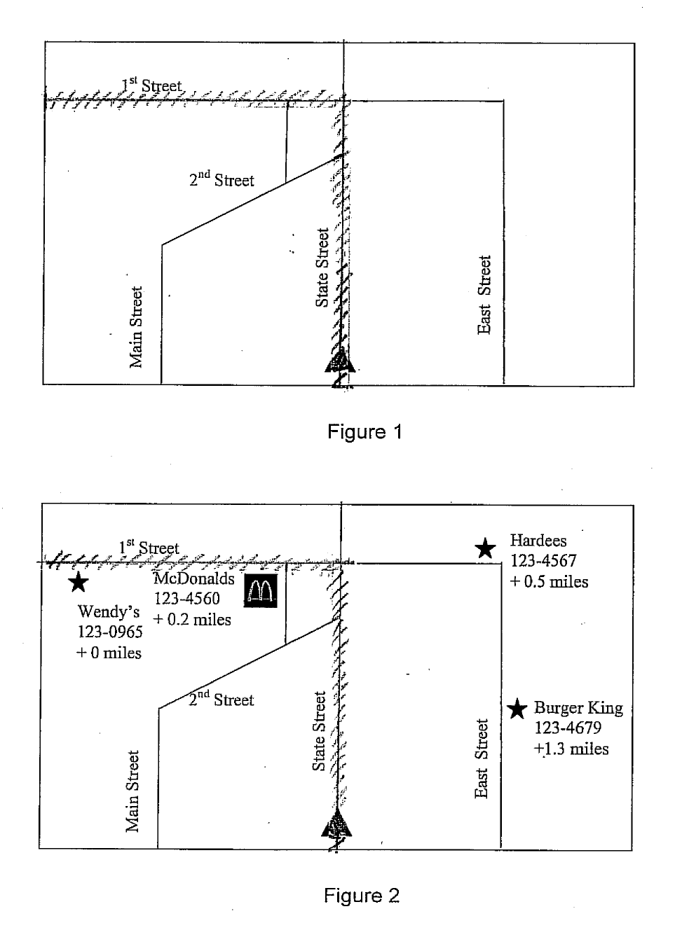

FIG. 1 depicts a navigation device that initially displays a moving map display to the user on a touchscreen. The user then makes a request of the navigator for locations matching certain criteria, either audibly or via a virtual keyboard displayed on the touchscreen. Locations best matching the criteria are then displayed on the moving map display. Locations for which advertising content is available are displayed with an icon differentiating them from locations for which no such information is available.

FIG. 2 shows the results of an example request. The user has requested the locations of the nearest fast food restaurants. Standard location icons indicate the location of nearby Wendy's, Hardees, and Burger King restaurants for which no advertising content is available. The location of a nearby McDonalds is indicated by that company's characteristic logo, indicating that advertising information is available to the user concerning that location. The icons may be differentiated by size, color, shape, animation, or other characteristics.

The user then has the option of commanding the navigation device to guide him to one of the locations on the map or to provide advertising content. A double tap by the user on the navigation device's touchscreen on any of the locations causes the navigation device to generate a route to the indicated location and guide the user to that location. If the user is already being guided by the navigation device along a route then the selected location may instead be incorporated into the route. A single tap by the user on an icon indicating the presence of advertising content causes the content to be presented. Alternative tactile, visual, or audible methods may be used by the user to command the navigation device.

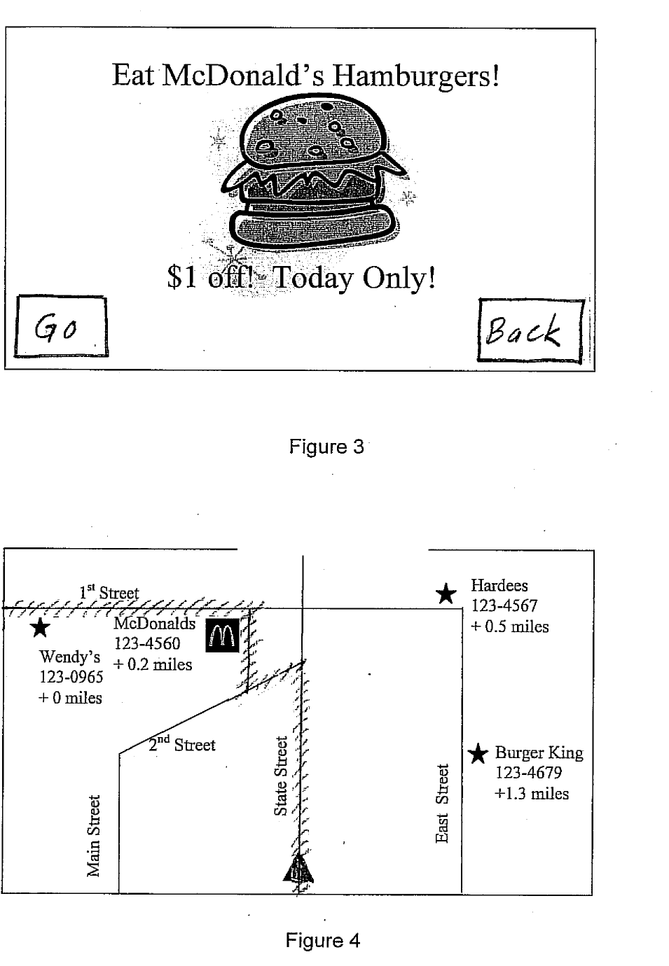

FIG. 3 shows an example of advertising content provided to the user. Such content may be images, video, sounds, text, or other means of conveying information to the user. Examples of such information include images of products, video of experiences, menus, sale information, and coupons. The user now has the opportunity may now command the navigation device to return to the previous display or to guide him to the advertised location. In this example, if the user touches “Go” on the touchscreen, the navigation device will, with no further user input, generate a route to the advertised location and provide guidance to the user as to how to follow the route.

FIG. 4 shows an example display resulting from the user touching “Go” on the screen shown in FIG. 3. The previous route has been modified to include the location of the selected McDonald's restaurant. In other embodiments, the initial user input resulting in the display of locations for which advertising is available can include a route request, specific location request, or other input. In all embodiments guidance to the user may be provided in visual, audible, image, text, map display, or other forms.

In other embodiments, the user can provide further input after commanding the navigator to guide to the selected location to effect changes in the routing, guidance, locations to be visited, and other aspects of generated routes and guidance. User inputs may be in audible, tactile, or visual form, and may be affected through various hardware controls that are part of or communicate with the navigation device.

The advertising information may be served out from a central location to the navigator as needed via a data link, or it may be loaded into the navigator and recalled when needed.

Information may be provided to aid in contacting a location either on the map display or on the advertisement.

If the user is already en route to a destination when a route to a location promoted by an advertisement is requested, the navigator may generate a route that includes both the original destination and the location promoted by the advertisement either with or without further user intervention.

If the user is already en route to a destination when locations matching criteria are requested, along with the locations displayed the navigator may provide information to the user as to the total travel time or distance of a route passing through the original destination and a new location or the additional travel time or distance in comparison to the original route.

This invention is of particular use in a wireless client-server navigator, which can be described as a system to aid a user in navigating by providing guidance made up of maps, routes, and/or instructions, and
1) which has mobile clients used for requesting and receiving guidance,
2) which has a central server that houses databases of geographical information, and generates guidance, and
3) in which data is transmitted between the mobile clients and central server.

I claim:

1. A method of conveying advertising information to a user of a navigation system, comprising the steps of:
receiving a user input or information about the user to infer which advertising content available to the system might be of interest to the user;
informing to the user that advertising content is available which may be of interest to the user;
receiving a command from the user to convey the advertising content;
conveying the advertising content to the user.

2. The method of claim 1, including the steps of:
receiving a request from the user to guide the user to a location associated with the advertising content; and
providing guidance to location to the user.

3. The method in claim 2, including the step of using a global positioning satellite (GPS) to determine the location.

4. The method of claim 1, wherein the information about the user includes the user's current, previous, or planned position.

5. The method of claim 1, wherein the information about the user includes demographic information about the user.

6. The method of claim 1, wherein the information about the user includes a previous input to the navigation system by the user.

7. The method of claim 2, wherein the guidance is provided through video, images, text, voice, or tones.

8. The method of claim 1, wherein the user input includes a request to be guided to a location.

9. The method of claim 1, wherein the user input includes a request for the location of places matching criteria provided by the user.

10. The method of claim 9, wherein the criteria include proximity to the user.

11. The method of claim 9, wherein the locations are businesses.

12. The method of claim 1, wherein the availability of advertising content is communicated to the user by displaying text or icons on a screen.

13. The method of claim 11, wherein indicators for locations for which advertising content is available are presented in a manner visually discemable from indicators for locations for which advertising content is not available.

14. The method of claim 1, wherein the advertising content is in audible, visual, image, or video form.

15. The method of claim 1, wherein the advertising content includes a coupon.

16. The method of claim 2, wherein no input by the user is required for the navigation system to generate the guidance.

17. The method of claim 2, wherein the user provides additional information to modify the guidance provided by the navigation system.

18. The method of claim 1, wherein the advertising content is stored at the location of the user.

19. The method of claim 1, wherein the advertising content is communicated to the user from a location other than the location of the user.

20. The method of claim 1, wherein the advertising content includes a telephone number, address, email address or other information enabling the user to contact a party associated with the advertisement.

21. The method of claim 2, wherein:
if the navigation system is previously guiding the user along a route, the location associated with the advertisement is added to the route; and
guidance is provided to the user to follow the modified route.

22. The method of claim 21, wherein the location associated with the advertisement is added to the existing route such the route is optimized to minimize distance along the route or minimize travel time in following the route.

23. The method of claim 21, wherein the modified route is generated and guidance is provided without further user input.

24. The method of claim 1, wherein information is provided to the user regarding straight-line distance, route distance, or estimated travel time from the user's position to the location associated with the advertisement.

25. The method of claim 1, wherein, if the navigation system is previously guiding the user along a route, information is provided to the user regarding additional travel distance or time if the location associated with the advertisement is added to the current route.

26. The method of claim 1, wherein the navigation system is a wireless client-server navigator.

27. The method of claim 2, wherein the user provides commands to the navigation system via a touchscreen.

28. The method of claim 25, wherein user commands to provide advertising information and user commands to provide guidance to a destination are differentiated by the manner in which the user interacts with the touchscreen.
